(19) United States
(12) Patent Application Publication
(10) Pub. No.: US 2018/0279652 A1
(43) Pub. Date: Oct. 4, 2018

(54) Edible Pet Chew with Meat Pulp On an Outside

(71) Applicant: Xiang Chen, Shanghai (CN)

(72) Inventor: Xiang Chen, Shanghai (CN)

(21) Appl. No.: 15/474,265

(22) Filed: Mar. 30, 2017

(51) Int. Cl. A23K 50/40; A23K 10/30; A23K 20/10

(52) U.S. Cl. CPC A23K 50/40; A23K 20/10; A23K 10/30

(57) ABSTRACT

A pet chew includes a primarily plant material base and a meat pulp material including a starch and stuck to an outside surface of the base. A method for manufacturing the pet chew is also provided.

The present invention relates to an edible pet chew and a preparation method of same.

### BACKGROUND OF THE INVENTION

U.S. Pat. No. 5,673,673 describes a knotted bone from rawhide, produced for the purpose of teeth grinding and chewing, has the disadvantages of mono-nutrition, excessively hard skin and poor palatability as well as environmental pollution, high cost and an insufficient source of raw materials. Similar rawhide dog chews, such as Dingo Ringo Rawhide treats with meat jerky wrapped in rawhide, are available commercially. Pressed dog chews made from rawhide with meat jerky in the midde is also commercially available.

U.S. Pat. No. 7,677,203, describes a knotted bone pet chew produced with plant starch as a main raw material for the outer casing, and a meat jerky as an interior layer.

Commercially available pressed chews such as Premium Pork Chomps from Pet Mountain or Greenies Dental Chews are also available.

### SUMMARY OF THE INVENTION

An object of the present invention is to provide a pet chew including primarily a plant material, while adding meat in a sufficient amount still being desirable to dogs. An alternate or additional object of the present invention is to simplify the manufacturing and provision of a mixed plant and meat based dog chew.

The present invention provides a pet chew comprising:

a primarily plant material base; and

a meat pulp material including a starch and stuck to an outside surface of the base.

Surprisingly, the meat pulp material of the present invention with the starch can be stuck directly to an outside of the plant material base without coming off quickly and still entice dogs to chew an entirety of the base. Complicated wrapping of jerky or other methods can be dispensed with and the chew can be simply manufactured.

Advantageously, the base has at least one recess, preferably along an entirety of at least one surface of the base, in which the meat pulp material is located.

The meat pulp material advantageously can be 75% or more by weight of meat, such as chicken, duck, lamb, salmon, pork or beef, and preferably has at least 7.5% wheat flour or other starch. Glycerin advantageously can be present, for example in a similar amount to the starch to improve the binding of the meat pulp. A small amount of potassium sorbate or other preservative can be added, for example at 0.1% weight percentage.

The plant material base is more than 50% plant material and preferably has a mixture of corn starch and a wheat, rice, or tapioca/cassava flour that is at least 65% by weight prior to drying, and then contains as well at least 10% by weight of meat to increase desirability and protein content. Glycerin may be present as well for binding, as well as dietary fiber, xanthan gum, yeast extract, potassium sorbate, vitamins, edible coloring and flavoring. Rice may be preferred for gluten-free products, and tapioca/cassava for grain free products.

The pet chew preferably is bone or ring-shaped, and the meat pulp material extends along an entire length of the bone-shaped base or an entire circumference of the ring.

The present invention also provides a method for manufacturing the pet chew described above comprising: molding the primarily plant based material into the base; adding the meat pulp material to the outside surface; and drying the base and the meat pulp material to form the pet chew.

Other process steps, such as sterilization, are provided as well.

### BRIEF DESCRIPTION OF THE DRAWINGS

FIG. 1 is a schematic view of one embodiment of the product of the present invention.

FIG. 2 is schematic view of another embodiment of the present invention.

### DETAILED DESCRIPTION

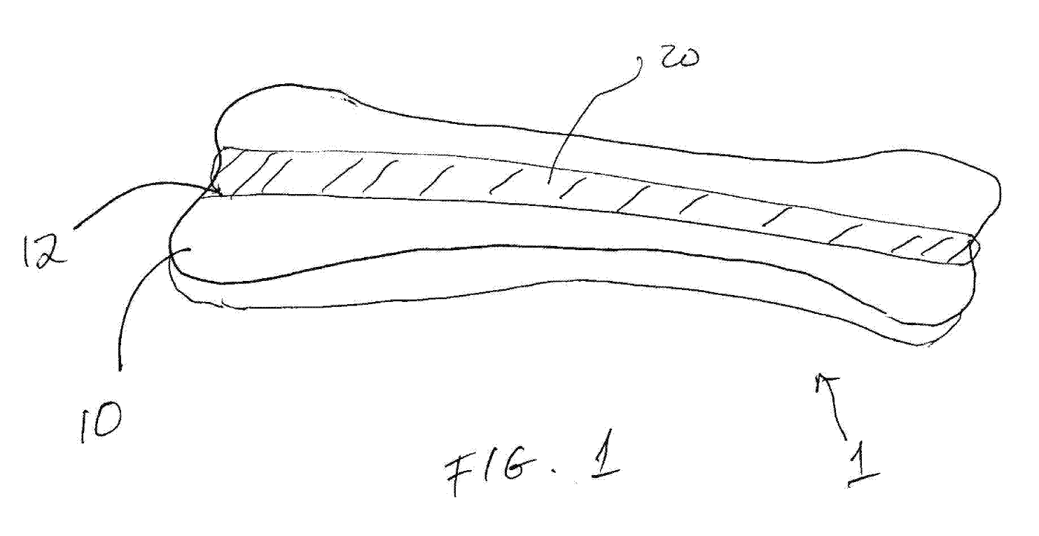

With reference to Fig.1, a bone-shaped pet chew 1 of the present invention includes a primarily plant material base 10, with a top surface having an indentation or recess 12. A meat pulp material 20 is located in the indentation or recess 12, and via the interaction of the plant material of the base 10 and the meat pulp material 20, the meat pulp material 20 sticks to the base 10. Surprisingly, the meat pulp material 20, as a dog chews the chew, does not detach as a whole from the base, but rather remains on the base 10 as, for example, a dog chews one end of the bone. Due to indentation 12 as well, it can be difficult for the dog to attempt to eat just the meat pulp material 20, and thus the dog chews and consumes both the plant material base and the meat pulp material 20 together.

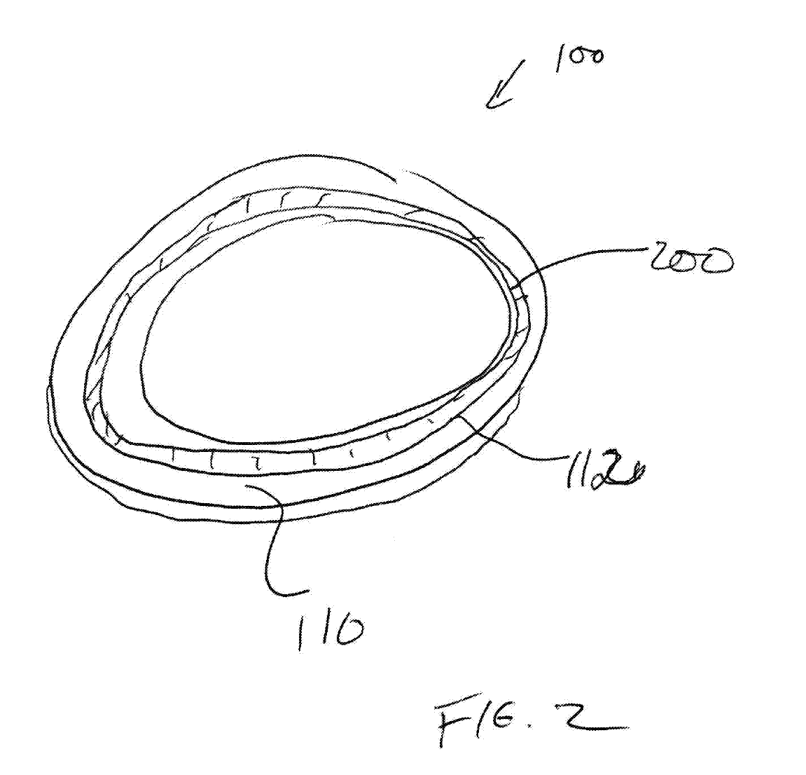

FIG. 2 shows a ring-shaped pet chew 100 of the present invention including a primarily plant material base 110, with a top surface having an indentation 112. A meat pulp material 200 is located in the indentation 112 and sticks to base 110.

In one preferred embodiment, the meat pulp material is a pulp comprising, prior to drying and in weight percentages: fresh chicken 80%, wheat flour 9%, glycerin 10.9%, and potassium sorbate 0.1%. The plant material base can be, prior to drying and in weight percentages: corn starch 45%, wheat flour 27%, chicken 8.5%, beef 5%, glycerin 10% dietary fiber 1.35%, xanthan gum 0.6%, yeast extract 2%, potassium sorbate 0.1%, vitamins 0.05% edible coloring 0.2%, and flavoring 0.2%.

The weight ratio of the meat pulp material to the plant material base material can vary depending on shapes and sizes, and for instance by having meat pulp material on more than just one side or surface of the base. Meat pulp material can be placed for example in both sides of the chews 1 and 100.

One example of the process for making the present dog chews is as follows:
1. Mix all the primarily plant material ingredients; and
2. Cook the mixture in an extruding machine with temperature between 100-120 degree for about 20 minutes.
3. Shape the mixture into strips through the mold on the extruding machine.
4. Cut the strips into smaller pieces
5. Molding: put the smaller pieces into molding machines and make into shapes
6. Drying: put the shaped product into oven for 48-72 hours with temperature of 70 degrees C. Dry pieces to or below a moisture level of 13%. Base is formed.
7. Add mixed and uncooked meat pulp material in the recess or indentation of the base products, on one or both sides.
8. Drying: drying the finished product with temperature of 60-70 degrees C. for about 30-55 hours and remove when the moisture level is 10%.
9. Sterilization: raise the temperature to 100 degrees C. to kill the bacteria.
10. Packaging

The present invention provides a surprisingly robust dog chew that is attractive to dogs and easily manufactured. The stickiness of the meat pulp material to the base according to the present invention is highly advantageous.

What is claimed is:

1. A pet chew comprising:
a primarily plant material base; and
a meat pulp material including a starch and stuck to an outside surface of the base.

2. The pet chew as recited in claim 1 wherein the base has at least one recess on the outside surface, the meat pulp material being located in the recess.

3. The pet chew as recited in claim 2 wherein the recess runs along an entirety of the surface, the meat pulp material filling the the recess.

4. The pet chew as recited in claim 1 wherein meat pulp material includes 75% or more by weight of meat.

5. The pet chew as recited in claim 1 wherein meat pulp material includes at least 7.5% by weight of the starch.

6. The pet chew as recited in claim 1 wherein meat pulp material includes at least 7.5% by weight of glycerin.

7. The pet chew as recited in claim 1 wherein the plant material base is more than 65% plant material.

8. The pet chew as recited in claim 1 wherein the plant material base is at least 10% by weight of meat.

9. The pet chew as recited in claim 1 wherein the pet chew is bone shaped.

10. The pet chew as recited in claim 1 wherein the pet chew is ring shaped.

11. A method for manufacturing the pet chew as recited in claim 1 comprising:
molding the primarily plant based material into the base;
adding the meat pulp material to the outside surface; and
drying the base and the meat pulp material to form the pet chew.
